(19) United States
(12) Patent Application Publication
(10) Pub. No.: US 2007/0164583 A1
(43) Pub. Date: Jul. 19, 2007

(54) Light weight passenger vehicle with expandable body size for collision protection

(75) Inventor: Chiou-Muh Jong, Ellicott City, MD (US)

Correspondence Address: Chiou-muh Jong, 11058 Dorsch Farm Road, Ellicott City, MD, 21042, US

(73) Assignee: Chiou-muh Jong, Ellicott City, MD (US)

(21) Appl. No.: 11/623,167

(22) Filed: Jan. 15, 2007

Related U.S. Application Data
(60) Provisional application No. 60/766,413, filed on Jan. 18, 2006.

(51) Int. Cl. B62D 25/00

(52) U.S. Cl. 296/187.03; 296/187.09; 296/187.12

(57) ABSTRACT

A new design for a light-weighted, preferably a battery-powered vehicle is disclosed. Small body size in the vehicle shrunk mode and being light weighted make the vehicle particularly suitable of using battery power and convenient to be driven in crowded urban area as an environment friendly passenger vehicle and can even be driven all the way from street to elevator and then parked into any apartment or condo in a high rise building. Furthermore, the vehicle can be operated in vehicle expanded mode such that, when operated on a regular street, its expanded size is comparable in body size to most other gasoline operated passenger cars and consequently gives better cushion for collision protection as well as better safety feeling for the driver and passengers.

### CROSS-REFERENCE INFORMATION

The present application claims the priority to co-pending U.S. Provision patent application Ser. No. 60/766,413 entitled “Light weight passenger vehicle with expandable body size for collision protection” filed on Jan. 20, 2006.

### FIELD OF INVENTION

The present invention relates to design of a light weighted passenger vehicle. Specifically, it relates to a totally different concept of constructing a passenger vehicle that is expandable in vehicle body size for better collision protection in both standing and moving conditions.

### STATE OF ART

Passenger cars are gradually getting more and more popular not only in developed world, but also in fast developing countries such as China and India. For example, the passenger car market in China has evolved from virtually nothing twenty years ago to a 7 million vehicles per year market at present time. Unfortunately, if such trend continues, China alone, as congested in its streets as it is now and with 1.2 billion citizens, soon will make unthinkable impact environmentally by offering too many gas-powered vehicles.

Despite some promising developments in greener technologies such as the advancement in fuel cell for hydrogen-powered vehicles, all such developments are still far away from being practical. Problems such as the hydrogen fuel distribution networks remains to be built make hydrogen-powered vehicles at least decades away from being able to enter commercial market. More recently, thanks to sudden rise in oil price, hybrid power vehicles are gradually getting attraction, but basically they are still gas power vehicles with a little improvement in fuel consumption and a little more environmental friendly in urban area.

To accommodate for limited space and congested traffic condition in urban area, some car manufacturers introduce micro mini cars in production. Notably the existence of super mini car of Smart brand manufactured by international giant auto company Daimler Chrysler, it is well designed and well built in good quality. However, it is still not an ideal transportation for urban area because, no matter how well Smart cars are built, the lack of being and feeling safe to drive in the streets will always exist for such super small vehicles. To tell the truth, such micro vehicles in general only achieves the goal of being small for easy manipulation and less fuel consumption in city driving, yet they still miss the even more important requirement-safe to drive along with a stream of various vehicles of all sizes. Another example is a newly ventured company named Accelerated Composites LLC in Carlsbad, Calif. is promoting its so called 3-wheeled, 330 mile per gallon, small hybrid diesel powered two seat concept car Aptera, aiming to be lightweight and thrifty in gas consumption. Obviously, it misses the important safety requirement too.

Battery electric vehicles have been invented over a century old, yet the usage of plug-in battery electric vehicles is still limited to some short distance, low speed transportation such as golf carts, commuting carts in big buildings and manufacturing facilities and handicap vehicles. Although many different models of electric cars have been developed in the passed century, none of them became competitive to vehicles powered by internal combustion engines. However, this will start to change due to awake of human regarding to environment pollution, which gives big push in searching for greener vehicle power sources. In fact, recent technology advances in the laptop computers and handheld gadgets have greatly improved the battery storage power so that the development of a practical electric vehicle powered through plug-in electrical energy source is getting more attention, along with some forms of hybrid power sources.

There is no doubt that a light-weighted, battery-powered, one or two passenger small vehicle (as compared in car body size to normal gas power passenger car) should be an ideal transportation for urban residents, not only in countries like China or India, but also ideal for most metro areas even in the big cities in developed world, for example, New York city where the streets are jammed with vehicles of all kinds as well as all sizes. In other words, it is time to take advantage of new battery technologies for a new breed of personal electric cars aiming at urban citizens. To achieve this goal, the new breed of cars should be pollution free and more importantly, safe to drive in the congested streets jammed with vehicles of bigger sizes.

It would be a practical advantage, as well as a good psychological practice of feeling safer if a micro vehicle for one or two passengers can expand its size to be comparable to that of a subcompact passenger car, for example, a Civic by Honda of Japan or a Mini Cooper by BMW of Germany, so that additional collision protection is immediately available. It is also an advantage that, if the micro vehicle can retract to it's original small size so that it is still small enough to travel in very narrow car paths, even can be driven into an elevator and a room in a high rise building.

Vehicles with expandable portion have been manufactured or in the proposals to be constructed for a long time. Currently, expansion of a vehicle is typically done by moving part of vehicle outer-shell for increasing roominess or by sliding out attached accessory portion for gaining extra cargo space.

However, such kind expansion is mainly aimed to increase space of the vehicle, not for increasing the safety feature of the vehicle. U.S. Pat. No. 4,132,444, for example, installed accordion hood to create a new expanded enclosed usable volume. U.S. Pat. No. 4,223,939, for another example, provided an attachment for converting a vehicle, such as a compact car, into an expandable vehicle having an enlarged expandable usable volume and similarities can be found on U.S. Pat. Nos. 5,971,459 and 6,474,714.

### SUMMARY OF THE INVENTION

To solve the dilemma of being small and light-weighted usually mutually exclusive to being safe, or in other words, to find the solution to the need of small vehicles light-weighted enough to use battery power for practical daily usage and yet practically and psychologically felt safe to be driven in a streets jammed with vehicles of all sizes, a vehicle capable of changing its size in both standing and moving conditions is invented.

It is therefore the intention of present invention to unveil a conceptually new kind light-weighted vehicle, safe enough to be driven in street jammed with vehicles of all sizes, yet light enough to be powered by batteries available in current market for traveling a distance, for example, over 100 miles per recharging, making vehicle practical for daily use. It is another intention of present invention to help solving congestion problem commonly existed in the big cities, by shrinking vehicle body to smaller size when traveling slow or parking in a smaller lot. It is yet another intention of current invention to reduce the severity of air pollution in urban area by this light-weighted vehicle not powered by internal combustion engines.

It is yet another intention of current invention to make less polluted, energy saving vehicle to be available for rental in the urban area, indirectly promoting the usage of public transportation for longer distance and switching to rental vehicles available through current invention.

A country with billion plus people, such as China, would make the fossil fuel consumption in the world unthinkably big and hazardous to the environment if one day the consumption level of its citizens reach that of US citizens when the ownerships of vehicles powered by internal engines in China close to the number in the United States. It is yet another goal of present invention to help relieving the problems in developing countries like China and India caused by increasing fossil fuel consumption which may gradually catch the level in developed world if no special care is devoted to such problems.

### BRIEF DESCRIPTION OF DRAWINGS

FIG. 1 shows the two modes of an expandable/retractable vehicle.

FIG. 2 shows the expandable head body module expanding in two dimensions.

FIG. 3 shows a section of vehicle in non-expanded and expanded modes for analysis of roll over in both cases.

### DETAILED DESCRIPTION OF INVENTION

The technology advances in light-weighted composite material applied to aviation industry has been obvious. In fact, composite material is not only good for the bodies of airplanes; it should be also as useful for the design of light-weighted vehicle. As mentioned previously, the concept car Aptera by Accelerated Composites LLC can reach to 330 miles per gallon of gas for being light-weighted of composite material, of being merely 850 lbs reflects some of the ideas for light vehicle design.

To design a new breed of car which is aiming to be practical for daily use in urban area, ideally some criteria should be in our minds—the car should be as small as possible to be able to move nimbly in the congested streets, seating not more than two people, should also be light enough to be powered by electricity only and, more importantly, should be safe to drive in the stream of automobiles of larger sizes. While composite material for car bodies is definitely a way to reduce the weight of a car, simplicity of power system (such as not to use internal combustion engine or hybrid system) and the size of car are two factors as important as well. After all, vehicles seating four or more passengers usually are unnecessarily big for maybe up to 90% of the trips going downtown. Apparently, current technologies are available to build a small electrical car, similar in size and weight to a golf cart, which has a cruise range of more than 100 miles per recharging and a top speed of 50 miles/hour. However, such vehicle is not considered as safe to drive on a regular street due to smallness and lack of collision protection.

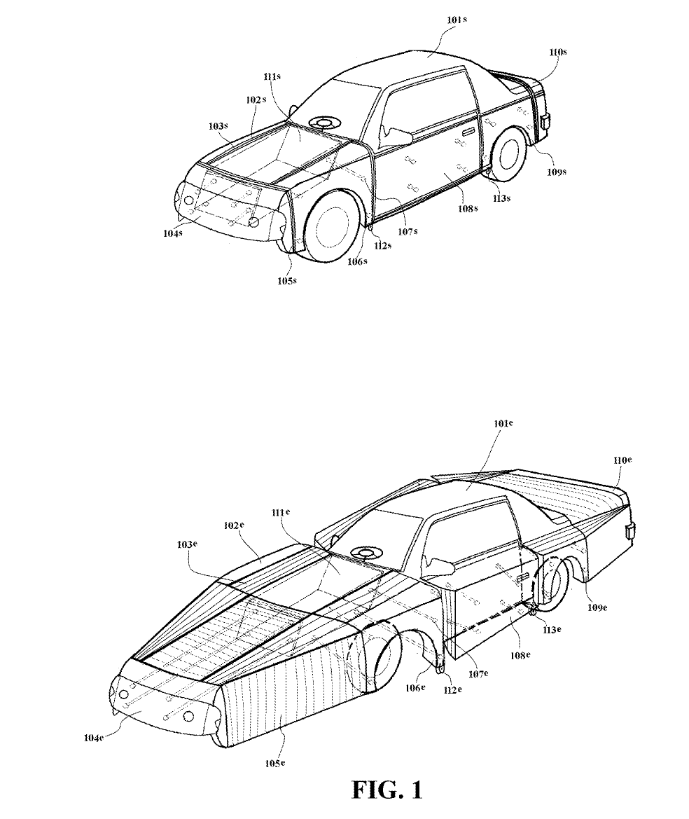

Referring to FIG. 1, 101s shows a small vehicle 101 with two seats in cascaded positions. An ideal dimensions for such a vehicle will have a total length of less than 100 inches, a width of 28-30 inches and wheel span width of less than 38 inches, so that it is possible to park such an vehicle inside a room in an apartment through a widened 42″ entrance door if the vehicle is powered by electricity only. These dimensions are for the vehicle in shrunk mode, as indicated in 101s.

Corresponding to 101s, there is 101e, which represents the expanded mode for the same vehicle 101. Surrounding this vehicle, there are one front end, two front wheel, two side-door, two rear wheel and one rear end expandable assemblies shown in FIG. 1 for illustration. Each s/e pair shows its shrunk and expanded mode respectively. 102s and 103s together constitute one of two front wheel expandable assemblies, with 102s being the out-shell portion and 103s the accordion like structure capable of expanding outward to form 103e while 102s remains unchanged to 102e. Similarly, 106s illustrates out-shell of the other front wheel expandable assembly, with 107s being a gas spring or hydraulic cylinder like structure responsible for expanding and retracting motions from 106s and 107s to 106e and 107e respectively.

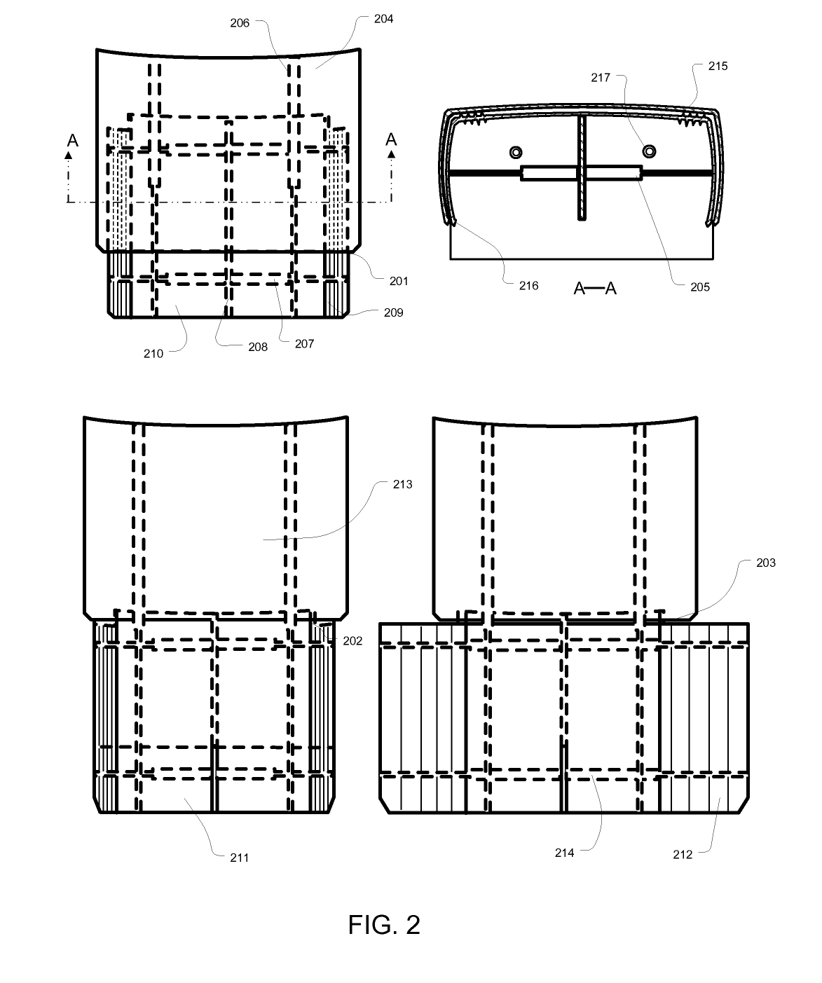

While 104s, 105s and their counterparts 104e, 105e illustrate the shrunk and expanded head body module, more details will be revealed in FIG. 2. For the front wheel body assemblies, with hydraulic cylinder or similar mechanisms such as gas spring 107s expands to 107e, the out-shell panel 106s will be moved sideward to 106e. FIG. 1 also clearly shows that the front wheel body assemblies have cavity holes, which make steering of front wheels possible.

Door body module is shown in FIG. 1 by 108s and 108e. It is an independent piece of vehicle expandable body, which allows passenger using it as entrance door while having expandable feature. Ideally, the vehicle should be designed in such a way that the driver should be able to easily activate the shrinking motion of the expanded vehicle such that the door body module will not interfere with front wheel body module in the process of exiting the vehicle from the door body assemblies.

Similarly, 109s/109e illustrate the expansion of rear wheel body assemblies, and 110s/110e pair for rear body module. All expandable assemblies together should be control in synchronous manner by an integral vehicle body size control device, which may be operated by pushing a button or buttons installed on vehicle instrumentation panel, and such body control system should also link with some function of instrumentation system such that there will be no undesired movements of the expandable body assemblies.

It is important to note that both head body module and rear body module are capable of expanding and retracting in two dimensions, or in other words, they can expand/retract in forward/backward direction as well as in sideward directions. In the case of head body module, the sideward expansion is to make 105e and 106e expand roughly same amount such that they look like the same piece in the vehicle expanded mode, yet in retracted mode 105s will be hided inside when the accordion structure with 106s shrinks to its minimum folding position. FIG. 2 shows an example to illustrate a design for the two dimensional expansion and contraction.

In FIGS. 2, 201, 202 and 203 show one implementation of three stages of expansion of the head body module (without showing the front bumper assembly for drawing simplification), say, 201 is in the beginning of expansion while 202 just finishing forward expansion and 203 has finished sideward expansion. In addition, FIG. 2 also illustrates the hydraulic cylinder like mechanism 206, which serves as one of the expanding mechanism to push inner cover layer 211 out until 206 extends to 213 position, with 207 plays similar role for sideward expansion when extracted to be 214 while expanding one of the accordion structure 209 to 212 position. The A-A section view of the head body module reveals the illustrative slidable two-layer structure 204 and 211 with their sectioned view 215 and 216 respectively of the assembly, and has mechanism 206 securely anchored to the front rigid section as 217. The section view also shows 215 securely to the mid-plate 208 as another hydraulic cylinder like mechanism anchored other than 207. Item 208 in turn must be anchored to inner cover 216, which is a section view of 211.

There are many ways of providing remotely controllable mechanism to achieve the expanding and retracting functions for the expandable assemblies. An obvious one is to use motor driven worm gear mechanism for slowly moving the accordion structure. Such mechanism is particularly suitable for the current invention for easy control, flexibility in expansion speed setting by wide range of available worm gear reduction ratio and low consumption of electricity, providing that the worm gear box and accessories are made of light material. Other ways include using hydraulic/pneumatic cylinder systems, airbags and spring combination and so on.

For a small vehicle with one or two passengers in cascade seating capacity, one main entrance door is enough for such a vehicle. However, for vehicle used in right lane traffic system, the main entrance door should be installed in the left side of the vehicle, and a second, not-as-easy exit such as a winding up-down glass for window and emergency exit can be used for right side of the vehicle to simplify the expandable body design for the right side of the vehicle body.

Other than the expandable body structure, implementation of current invention to a small passenger vehicle should no exceptionally still include important systems such as wheel system, steering system seating structure, transmission system and power system etc. To make the vehicle as light as possible, a plain steering system without power assistance should be considered, aluminum or other light material with enough strength can be used to construct the vehicle chassis, while fiber glass material is a good choice for the construction of out-shell panels. If a motor wheel is used for every drive wheel, the transmission system can be minimized to just including power cables with control lines linking to each wheel, instrumentation system and speed control device such as an accelerating pedal.

Battery power, up to now, is obvious choice as the sole power source for the implementation of current invention, which can be recharged easily through a plug-in device connecting to the power outlet available in the car garage. However, in order to extend cruise mileage, a small, constant speed internal combustion engine may also be used for generating electricity if needed. This hybrid system may be more useful for less populated suburban area.

Currently, batteries power a lot of golf carts available in the golf courses. Such two-seated golf carts typically have overall lengths of 94″ and widths of about 47″. An implementation based on current invention can lead to a vehicle with similar size. However, the width of 47″ spanned by parallel seating for two passengers in the golf carts can be reduced to, say, 38″ for a single person vehicle or a cascaded two-seater for preferred implementation of current invention. Such a cascaded two-seater then would preferably have a shrunk size of roughly 110″ of overall length and a width of 38″ or so. Since typical subcompact cars such as BMW 3 series or Honda Civic have overall lengths about 168″ and width about 67″, obviously an expanded size of 160″ in overall length and 60″ width would be close in size to most subcompact cars running on the streets. This translates to the expansions of 25″ for the front and real body modules and 11″ for each side expansion. A 25″ expansion in head body module implies a front rigid section would have at least 30″ in length, and similarly for rigid rear section. Such design leaves an available length of roughly 50″ for the passenger compartment, which is adequate room for a full driver seat and a smaller backseat. Although other arrangements in designing the chassis and expansion ratios are all in possible scenario, the overall length of close to 100″ is a preferred shrunk length for implementation because it would then easily park two cars bumper to bumper in a commonly partitioned parking space in most of current parking lots.

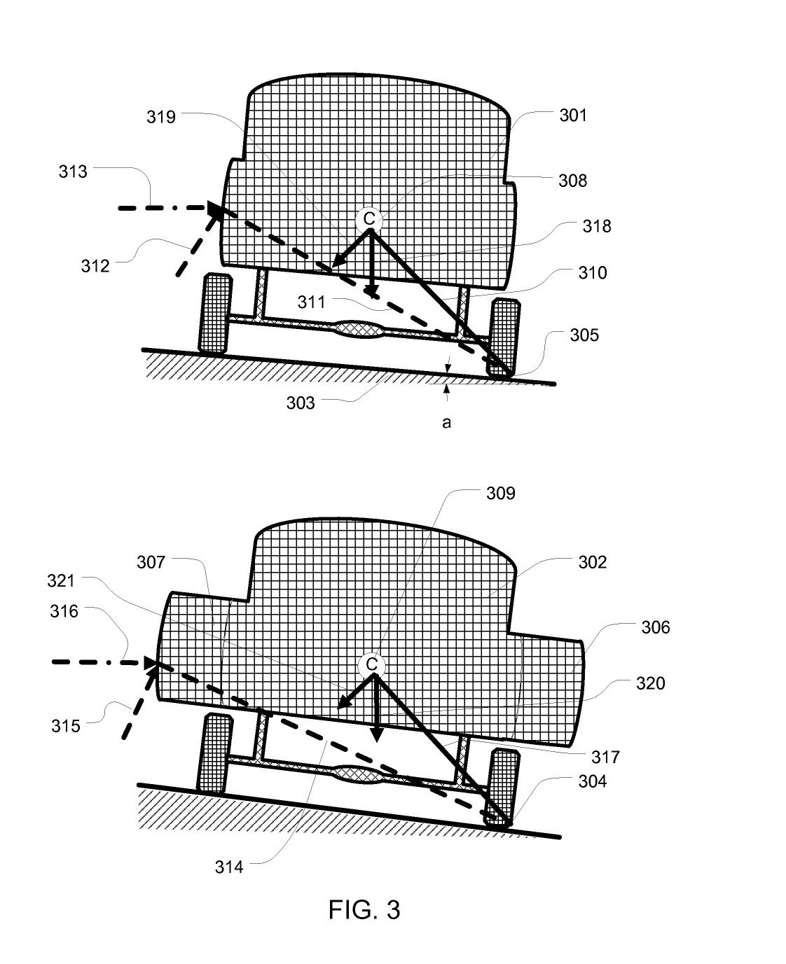

FIG. 3 shows a section view of a vehicle in shrunk mode and expanded mode for rollover analysis. The section of vehicle 301, when expanded to be 302, with expanded portion 306 and 307 is shown on a road 303 having an angle “a” with the horizontal surface. Arrow 318 shows the weight of the vehicle, represented by the centroid C of the vehicle, which can be decomposed into two force components, namely, the arrow 319 perpendicular to the arm 310 and another component (not shown) parallel to arm 310. If a moment associated with any force such as 312 or 313 is larger than the product of 310 and 319, then the vehicle will roll over to right hand side. Similarly, if any moment such as product of 315 to 314 (assume they are perpendicular to each other) or moment associated with force 316 is larger than the product of force 321 and arm 317, the expanded vehicle will roll over too. Clearly, it shows that the amount of moment to tip over the vehicle in both shrunk mode and expanded mode is the same, because the weight of the vehicle and location of centroid are not changed during expansion and retraction. This also implies that, in both modes, the effect of moment due to centrifugal force, which depends only to the speed of vehicle, radius of turning, weight of vehicle and vertical distance from centroid to the ground, to roll over of the vehicle is the same, regardless of the expansion of body size. However, if a vertical force applies simultaneously to both modes, the expanded mode will be easier to tip over due to the expansion portion of 307, which contributes to longer horizontal component of moment arm. If there still have concern about rollover (for quieting users who have suspicion regarding to above rollover analysis), small sliding wheels such as 112s/112e and 113s/113e can be installed.

Ideally, the weight ratio of expandable portion to the rest weight of vehicle should be kept to minimum to avoid worsening too much to the handling of vehicle. Fortunately, for a vehicle designed to serve in the urban area, the maximum speed should be kept under, say, 50 miles per hour and it should be kept away from running on the high-speed allowable highway. This limitation in speed design should ease the concern over the handling of such expanded, bulky looking vehicles.

Undoubtedly, installation of expandable/retractable modules to a small vehicle will increase a substantial portion to its overall vehicle weight. However, we need to know that the out-shell panels of all expandable/retractable modules are necessary skins for a vehicle without such modules. This implies that the major increase of weight comes from additional mechanisms driving expansion and retraction motions, which is not really that much, as compared to the rest of so many items of the vehicle. Careful use of body module material and good management of weight distribution can make a mere 10% increase in vehicle total weights due to function of expansion and retraction an achievable goal.

Within foreseeable future, the improving battery technology soon will be able to store enough energy into a new version of batteries, and these batteries will make the cruise range of a small electric vehicle in the range of, say, more than 100 miles between recharges, and the most crucial criteria—being light weight for current invention will also gradually more and more relief. However, even with today's technology in the Lithium-Ion batteries and the new trend toward plug-in hybrid power vehicle, it should be technologically ready in designing and manufacturing a practical light-weighted passenger cars with reasonable battery cost and reasonable cruise range for daily use. Therefore, the advantages of current invention, if we compare the expandable four wheel vehicle by current invention to a motor cycle, we already can see that not only it has the advantage of weighting in the same order as a motor cycle, it also can protects passengers much better in the traffic, and much more conveniences in shielding bad weather such as rainfall, snow and sun light, with almost same operating cost.

It is not deniable that all the battery power vehicles cannot compete to the gasoline power automobile in providing such luxury conveniences as air conditioning and other power assisted devices due to limited energy in battery. This, however, can be tolerable because most trips using such vehicles are relatively short and slower. Electric vehicles for urban usage are not built to replace other modern automobiles, they are built for alternative driving needs.

Still, there is one more advantage to develop the vehicles implemented in current invention. Such vehicles are especially useful as rental cars in urban area for the short trip of one or two person in business and other purposes. In fact, a big portion of rental car business is for one or two persons with very limited traveling distance. If there are abundant rental cars of expandable size, it will naturally promote more business in public transportation such as trains, bus and airline and consequently reducing the amount of automobile traffic into urban area.

What is claimed is:

1. A light-weighted motorized passenger vehicle comprising:
a chassis having a central vehicle frame with a least a door opening in each side therein;
a rigid front section securely fixed to front portion of said central vehicle frame;
a rigid rear section securely fixed to rear portion of said central vehicle frame;
an expandable-retractable body assembly enclosing said rigid front section, said rigid rear section and enclosing non-glass, lower portion of said chassis; and
an integral vehicle body size control device for integrally linking and controlling said expandable-retractable body assembly, whereby said expandable-retractable body assembly of said light-weighted motorized passenger vehicle is expandable to a predetermined expanded size for gaining extra collision protection and retractable to a predetermined retracted size for easier handling in narrow alley in vehicle moving and standing conditions under a plurality of different driving environments.

2. The motorized passenger vehicle according to claim 1, wherein said chassis further comprising:
a vehicle wheel system;
a vehicle steering system;
a vehicle seating structure;
a vehicle power system;
an instrumentation system for manipulating said motorized passenger vehicle in a predetermined speed range and a predetermined load, and for monitoring performance of said motorized passenger vehicle; and
a means for interfacing said integral vehicle body size control device and said instrumentation system.

3. The motorized passenger vehicle according to claim 1, wherein said expandable-retractable body assembly further comprising a head body module which further comprising:
a front bumper mechanism;
a front bumper assembly having a headlight assembly coupled securely with said front bumper mechanism;
a means having a generic accordion structure, capable of being expanded in forward and sideward directions to a predetermined expanded size and retracted in backward and sideward directions to a predetermined shrunk size; said means is sandwiched securely between said front bumper assembly and front portion of said rigid front section;
a mechanism securely attached to said central vehicle frame for performing actions of expanding and retracting said head body module; and
an interface means coupling said head body module to said integral vehicle body size control device for synchronized control of expanding and retracting said expandable-retractable body assembly.

4. The motorized passenger vehicle according to claim 1, wherein said expandable-retractable body assembly further comprising a front wheel body module for each front wheel of said motorized passenger vehicle, said front wheel body module further comprising:
a front wheel side out-shell panel having a cavity portion for free movement of front wheel;
a means having a generic accordion structure and a cavity portion for free movement of front wheel, said means is expandable to a predetermined expanded size and retractable to a predetermined shrunk size and sandwiched securely between said out-shell panel and side portion of said rigid front section;
a mechanism securely attached to said rigid front section for performing the actions of expanding and retracting said front wheel body module; and
an interface means coupling said front wheel body module to said integral vehicle body size control device for synchronized control of expanding and retracting vehicle body of said motorized passenger vehicle.

5. The motorized passenger vehicle according to claim 1, wherein said expandable-retractable body assembly further comprising a door body module which further comprising:
an out-shell door panel having a rigid structure;
an inner-shell door panel having a rigid structure;
a means having a generic accordion structure, expandable to a predetermined expanded size and retractable to a predetermined shrunk size, said means is sandwiched securely between said out-shell door panel and said inner-shell door panel;
a mechanism securely attached to said inner-shell door panel for performing the actions of expanding and retracting said door body module; and
an interface means coupling said door body module to said integral vehicle body size control device for synchronized control of expanding and retracting vehicle body of said motorized passenger vehicle.

6. The motorized passenger vehicle according to claim 1, wherein said expandable-retractable body assembly further comprising a rear wheel body module in each side of said motorized passenger vehicle, said rear wheel body module further comprising:
a rear wheel side out-shell panel in each of the two rear wheel sides, having a rigid in structure and a cavity portion for allowing free movement of rear wheel of said motorized passenger vehicle;
a means having a generic accordion structure and having a cavity portion for allowing free movement of rear wheel, said means is expandable to a predetermined expanded size and retractable to a predetermined shrunk size and is sandwiched securely between sand out-shell panel and side portion of said rigid rear section;
a mechanism securely attached to said rigid rear section for performing the actions of expanding and retracting said rear wheel body module; and
an interface means coupling said rear wheel body module to said integral vehicle body size control device for synchronized control of expanding and retracting vehicle body of said motorized passenger vehicle.

7. The motorized passenger vehicle according to claim 1, wherein said expandable-retractable body assembly further comprising a rear body module in each side of said motorized passenger vehicle, said rear body module further comprising:
a rear bumper mechanism;
a tail light assembly securely coupling to said rear bumper mechanism as a rigid rear bumper assembly;
a means having a generic accordion structure, capable of being expanded in forward and sideward directions to a predetermined expanded size and retracted in backward and sideward directions to a predetermined shrunk size, and sandwiched securely between said rear bumper assembly and said rear portion of said rigid rear section;
a mechanism securely attached to said central vehicle frame for performing the actions of expanding and retracting said rear body module; and
an interface means coupling said rear body module to said integral vehicle body size control device for synchronized control of expanding and retracting vehicle body of said motorized passenger vehicle.

8. A method of constructing a light-weighted motorized passenger vehicle comprising the steps of:
constructing a chassis having a central vehicle frame with a least a door opening in each side thereof;
attaching securely a rigid front section to front portion of said central vehicle frame; attaching securely a rigid rear section to rear portion of said central vehicle frame;
constructing a expandable-retractable body assembly enclosing said rigid front section, said rigid rear section and further enclosing non-glass, lower portion of said chassis; and
installing an integral vehicle body size control device for integrally linking and controlling said expandable-retractable body assembly, whereby said expandable-retractable body assembly of said light-weighted motorized passenger vehicle is expandable to a predetermined expanded size for gaining extra collision protection and retractable to a predetermined retracted size for easier handling in narrow alley in vehicle moving and standing conditions under a plurality of different driving environments.

9. The method according to claim 8, wherein said main vehicle assembly further comprising:
a vehicle wheel system;
a vehicle steering system;
a vehicle seating structure;
a vehicle power system;
an instrumentation system for manipulating said motorized passenger vehicle in a predetermined speed range and a predetermined load, and for monitoring performance of said motorized passenger vehicle; and
a means for interfacing said integral vehicle body size control device and said instrumentation system.

10. The method according to claim 8, wherein the step of constructing said expandable-retractable body assembly further comprising constructing a head body module in steps of:
constructing a front bumper mechanism;
assembling a headlight assembly securely to said bumper mechanism as a front bumper assembly;
constructing a means having a generic accordion structure, capable of being expanded in forward and sideward directions to a predetermined expanded size and retracted in backward and sideward directions to a predetermined shrunk size; said means is sandwiched securely between said front bumper assembly and front portion of said rigid front section;
attaching a mechanism securely to said central vehicle frame for performing actions of expanding and retracting said head body module; and
installing an interface means coupling said head body module to said integral vehicle body size control device for synchronized control of expanding and retracting said expandable-retractable body assembly.

11. The method according to claim 8, wherein the step of constructing said expandable-retractable body assembly further comprising constructing a front wheel body module in steps of:
constructing a front wheel side out-shell panel having a cavity portion for free movement of front wheel;
constructing a means having a generic accordion structure and a cavity portion for free movement of front wheel, said means is expandable to a predetermined expanded size and retractable to a predetermined shrunk size and sandwiched securely between said out-shell panel and side portion of said rigid front section;
attaching a mechanism securely to said rigid front section for performing the actions of expanding and retracting said front wheel body module; and
installing an interface means coupling said front wheel body module to said integral vehicle body size control device for synchronized control of expanding and retracting vehicle body of said motorized passenger vehicle.

12. The method according to claim 8, wherein the step of constructing said expandable-retractable body assembly further comprising constructing a door body module in steps of:
constructing an out-shell door panel having a rigid structure;
constructing an inner-shell door panel having a rigid structure;
constructing a means having a generic accordion structure, expandable to a predetermined expanded size and retractable to a predetermined shrunk size, said means is sandwiched securely between said out-shell door panel and said inner-shell door panel;
attaching a mechanism securely to said inner-shell door panel for performing the actions of expanding and retracting said door body module; and
installing an interface means coupling said door body module to said integral vehicle body size control device for synchronized control of expanding and retracting vehicle body of said motorized passenger vehicle.

13. The method according to claim 8, wherein the step of constructing said expandable-retractable body assembly further comprising constructing a rear wheel body module in steps of:
constructing a rear wheel side out-shell panel in each of the two rear wheel sides, having a rigid in structure and a cavity portion for allowing free movement of rear wheel of said motorized passenger vehicle;
constructing a means having a generic accordion structure and having a cavity portion for allowing free movement of rear wheel, said means is expandable to a predetermined expanded size and retractable to a predetermined shrunk size and is sandwiched securely between sand out-shell panel and side portion of said rigid rear section;
attaching a mechanism securely to said rigid rear section for performing the actions of expanding and retracting said rear wheel body module; and
installing an interface means coupling said rear wheel body module to said integral vehicle body size control device for synchronized control of expanding and retracting vehicle body of said motorized passenger vehicle.

14. The method according to claim 8, wherein the step of constructing said expandable-retractable body assembly further comprising constructing a rear body module in steps of:
constructing a rear bumper mechanism;
coupling a tail light assembly securely to said rear bumper mechanism as a rigid rear bumper assembly;
constructing a means having a generic accordion structure, capable of being expanded in forward and sideward directions to a predetermined expanded size and retracted in backward and sideward directions to a predetermined shrunk size, and sandwiched securely between said rear bumper assembly and said rear portion of said rigid rear section;
attaching a mechanism securely to said central vehicle frame for performing the actions of expanding and retracting said rear body module; and
installing an interface means coupling said rear body module to said integral vehicle body size control device for synchronized control of expanding and retracting vehicle body of said motorized passenger vehicle.

15. A light-weighted powered passenger car having an expandable and retractable car body comprising:
a main vehicle assembly having a central vehicle frame which includes a least a door opening in each side of said central vehicle frame, said main vehicle assembly further comprising a vehicle wheel system, a vehicle steering system, a vehicle seating structure, a vehicle power system and an instrumentation system for manipulating said motorized passenger vehicle in a predetermined speed range and a predetermined load, and for monitoring performance of said motorized passenger vehicle;
a rigid front section securely fixed to front portion of said central vehicle frame;
a rigid rear section securely fixed to rear portion of said central vehicle frame;
a front expandable-retractable body assembly securely attached to said rigid front section and capable of expanding forward and sideward to a predetermined expanded size and capable of retracting backward and sideward to a predetermined retracted size;
a side expandable-retractable body assembly for each side of said main vehicle assembly, securely attached to each side of said central vehicle frame and capable of expanding to a predetermined expanded size and retracting to a predetermined retracted size;
a rear expandable-retractable body assembly securely attached to said rigid rear section and capable of expanding backward and sideward to a predetermined expanded size and retracting forward and sideward to a predetermined retracted size; and
an integral vehicle body size control device for integrally linking and controlling said front expandable-retractable body assembly, said side expandable-retractable body assembly, said rear expandable-retractable body assembly and said instrumentation system, whereby said light-weighted powered passenger vehicle is expandable for gaining extra collision protection and retractable for narrow alley handling in vehicle moving and standing conditions under a plurality of different driving environments.
